(19) United States
(12) Patent Application Publication
(10) Pub. No.: US 2023/0211317 A1
(43) Pub. Date: Jul. 6, 2023

(54) COMPOSITION FOR FORMING UNDERCOAT LAYER, UNDERCOAT LAYER, AS WELL AS EXHAUST GAS PURIFICATION CATALYST AND EXHAUST GAS PURIFICATION APPARATUS INCLUDING UNDERCOAT LAYER

(71) Applicant: MITSUI MINING & SMELTING CO., LTD., Tokyo (JP)

(72) Inventors: Hiromu WATANABE, Saitama (JP); Masato MATSUZAWA, Saitama (JP)

(21) Appl. No.: 18/008,887

(22) PCT Filed: Jun. 8, 2021
(86) PCT No.: PCT/JP2021/021686

§ 371 Date: Dec. 7, 2022

(30) Foreign Application Priority Data
Jun. 9, 2020 (JP) 2020-100418

(51) Int. Cl. B01J 23/14; B01J 23/46; B01J 35/00; B01J 35/02; B01J 35/10; B01D 53/86; B01D 53/94; F01N 3/28

(52) U.S. Cl. CPC B01J 23/14; B01D 53/94; B01D 53/864; B01J 23/468; B01J 35/0013; B01J 35/026; B01J 35/1009; B01J 35/1014; B01J 35/1019; B01J 35/1071; F01N 3/2828; B01D 2255/1021; B01D 2255/9155; B01D 2257/7025; F01N 2330/30; F01N 2370/02

(57) ABSTRACT

An object of the present invention is to provide a composition for forming an undercoat layer capable of forming an undercoat layer that does not easily peel off from the substrate, an undercoat layer formed by the composition, as well as an exhaust gas purification catalyst and an exhaust gas purification apparatus each including the undercoat layer, and, to achieve the object, the present invention provides a composition for forming an undercoat layer, the composition containing tin oxide microparticles and tin oxide nanoparticles, wherein a content of the tin oxide nanoparticles is 8% by mass or more and 30% by mass or less, with respect to a total content of the tin oxide microparticles and the tin oxide nanoparticles, an undercoat layer formed by the composition, as well as an exhaust gas purification catalyst and an exhaust gas purification apparatus each including the undercoat layer.

### BACKGROUND OF THE INVENTION

### Field of the Invention

The present invention relates to a composition for forming an undercoat layer, an undercoat layer formed by the composition for forming an undercoat layer, as well as an exhaust gas purification catalyst and an exhaust gas purification apparatus each including the undercoat layer.

### Background Art

Exhaust gas emitted from an internal combustion engine of an automobile, a motorcycle, a boiler, a heating furnace, a gas engine, a gas turbine or the like contains harmful components, such as hydrocarbons (HC), carbon monoxide (CO) and nitrogen oxide (NOx). As an exhaust gas purification catalyst that purifies and detoxifies these harmful components, a three-way catalyst having a catalytic activity to oxidize HC and CO and convert them to water and carbon dioxide, as well as to reduce NOx and convert it to nitrogen, has been used.

There are cases where three-way catalysts do not effectively act on methane in exhaust gases. Therefore, methane oxidation catalysts have been developed. For example, Patent Document 1 discloses a methane oxidation catalyst in which platinum and iridium are supported on tin oxide. The methane oxidation catalyst disclosed in Patent Document 1 is capable of effectively removing methane by oxidation in a low temperature range (500° C. or lower, particularly from 350 to 450° C.).

### CITATION LIST

### Patent Document

Patent Document 1: JP 2006-272079 A

### SUMMARY OF THE INVENTION

### Technical Problem

An exhaust gas purification catalyst includes a substrate and a catalyst layer formed on the substrate. In cases where the substrate has a honeycomb structure composed of a plurality of cells, the portions of the catalyst layer formed at the corners of the cells (corners of the cells when the substrate is seen in a plan view from the axial direction of the substrate) have a low contact efficiency with an exhaust gas, and may fail to exhibit a sufficient catalytic performance. As a way to prevent the above-described problem, it is possible to form an undercoat layer on the substrate, and to form the catalyst layer on the undercoat layer.

Depending on the composition of the undercoat layer, however, there are cases where the undercoat layer may easily peel off from the substrate.

Accordingly, an object of the present invention is to provide a composition for forming an undercoat layer capable of forming an undercoat layer that does not easily peel off from the substrate, an undercoat layer formed by the composition for forming an undercoat layer, as well as an exhaust gas purification catalyst and an exhaust gas purification apparatus each including the undercoat layer.

### Solution to Problem

To achieve the object, the present invention provides the following inventions.

A composition for forming an undercoat layer, the composition containing tin oxide microparticles and tin oxide nanoparticles,

wherein a content of the tin oxide nanoparticles is 8% by mass or more and 30% by mass or less, with respect to a total content of the tin oxide microparticles and the tin oxide nanoparticles.

An undercoat layer formed by the composition for forming an undercoat layer according to [1].

An exhaust gas purification catalyst including:
a substrate;
the undercoat layer according to [2] formed on the substrate; and
a catalyst layer formed on the undercoat layer.

An exhaust gas purification apparatus including the exhaust gas purification catalyst according to [3].

### Advantageous Effects of Invention

The present invention provides a composition for forming an undercoat layer capable of forming an undercoat layer that does not easily peel off from the substrate, an undercoat layer formed by the composition for forming an undercoat layer, as well as an exhaust gas purification catalyst and an exhaust gas purification apparatus each including the undercoat layer.

### BRIEF DESCRIPTION OF THE DRAWINGS

FIG. 1 is a partial cross-sectional view of an exhaust gas purification apparatus 1 according to one embodiment of the present invention.

FIG. 2 is a cross-sectional view of the apparatus shown in FIG. 1 taken along the line A-A.

### DETAILED DESCRIPTION OF THE INVENTION

The present invention will now be described in specific detail.

### Composition For Forming Undercoat Layer

The composition for forming an undercoat layer according to the present invention contains tin oxide microparticles and tin oxide nanoparticles.

The tin oxide microparticles are a matrix component, and the tin oxide nanoparticles are a binder component. That is, when the composition for forming an undercoat layer according to the present invention is used to form an undercoat layer on a substrate, the tin oxide microparticles forms the base material of the undercoat layer, and the tin oxide nanoparticles bind the substrate with tin oxide microparticles as well as allows the tin oxide microparticles to bind with each other.

The tin oxide particles contain tin oxide. Examples of the tin oxide include tin (II) oxide (SnO), tin (III) oxide (Sn₂O₃), tin (IV) oxide (SnO₂) and tin (VI) oxide (SnO₃). Among these, tin oxide (IV) (SnO₂) is preferred. The tin oxide particles may contain one kind of tin oxide, or two or more kinds of tin oxides.

The content of tin oxide in the tin oxide particles is usually 75% by mass or more, preferably 80% by mass or more, and more preferably 90% by mass or more, with respect to the mass of the tin oxide particles. In cases where the tin oxide particles contain one kind of tin oxide, the “content of tin oxide” refers to the content of the one kind of tin oxide, and in cases where the tin oxide particles contain two or more kinds of tin oxides, the “content of tin oxide” refers to the total content of the two or more kinds of tin oxides. Although the upper limit value of the content of tin oxide is theoretically 100% by mass, the upper limit can actually be less than 100% by mass (such as 99.5% by mass or less) considering the presence of unavoidable impurities. Unavoidable impurities are, for example, trace elements unavoidably mixed during the production of the tin oxide particles.

In cases where the tin oxide particles contain tin (IV) oxide, the content of tin (IV) oxide in the tin oxide particles is preferably 75% by mass or more, more preferably 80% by mass or more, and still more preferably 90% by mass or more, with respect to the mass of the tin oxide particles.

The amounts of elements contained in the tin oxide particles can be measured using a conventional method such as inductively coupled plasma emission spectrophotometry (ICP-AES).

The tin oxide particles are preferably in the form of spheres. The definition of the form of spheres includes the forms of true spheres, oval spheres and the like.

Both the tin oxide microparticles and the tin oxide nanoparticles are composed of a plurality of tin oxide particles. The above-described description of the tin oxide particles applies to both the tin oxide particles constituting the tin oxide microparticles and the tin oxide particles constituting the tin oxide nanoparticles.

Both the tin oxide microparticles and the tin oxide nanoparticles may be composed of a plurality of tin oxide particles having the same composition, or may be composed of a plurality of tin oxide particles having different compositions.

The tin oxide microparticles have a median diameter D₅₀ of a micrometer size, and the tin oxide nanoparticles have a median diameter D₅₀ of a nanometer size.

The median diameter D₅₀ of the tin oxide microparticles refers to the particle size at which the cumulative volume is 50% in the particle size distribution based on volume of the tin oxide microparticles, and the median diameter D₅₀ of the tin oxide nanoparticles refers to the particle size at which the cumulative volume is 50% in the particle size distribution based on volume of the tin oxide nanoparticles.

The particle size distribution based on volume of the tin oxide microparticles is measured by the dynamic light scattering method. In the dynamic light scattering method, the particle size distribution based on volume of the tin oxide microparticles is measured using, for example, a particle size distribution measuring apparatus, “Zetasizer Nano ZS” manufactured by Malvern Panalytical Inc. The particle size distribution is measured by dispersing the tin oxide microparticles in water.

The particle size distribution based on volume of the tin oxide nanoparticles is measured by the small angle X-ray scattering method. A preferred embodiment of the small angle X-ray scattering method is as follows. A glass sample plate having a recess with a depth of 0.2 µm is prepared, and the recess is filled with a powder containing the tin oxide nanoparticles at an arbitrary proportion, to prepare a sample. In order to obtain a small angle X-ray scattering profile, the small angle X-ray scattering specification as an optical system is applied to a fully automatic multi-purpose x-ray diffractometer, SmartLab, manufactured by Rigaku Corporation, and the small angle X-ray scattering profile of the sample is measured by the transmission method. A Cu target is used as the x-ray source, and a scintillation counter is used as the detector. Subsequently, a profile analysis of the small angle X-ray scattering profile of the sample is carried out using analysis software, NANO-Solver, manufactured by Rigaku Corporation, assuming that the particles are in the form of spheres, and that the variation in particle size is given by a gamma distribution function. The target angle range in the profile analysis is set to be up to 2θ = 4 deg.

The dynamic light scattering method measures an apparent particle size. That is, when the particles are present in the form of primary particles, the primary particle size is measured; and when the particles are present in the form of secondary particles formed by the aggregation of primary particles, the secondary particle size is measured. In contrast, the small angle X-ray scattering method measures the primary particle size, regardless of the particles being primary particles or secondary particles. Secondary particles are aggregated particles formed by the aggregation of primary particles.

The measurement of the particle size distribution based on volume of the tin oxide microparticles and of the tin oxide nanoparticles may be carried out before mixing the tin oxide microparticles and the tin oxide nanoparticles, or after mixing the tin oxide microparticles and the tin oxide nanoparticles. The measurement of the particle size distribution based on volume of the tin oxide microparticles and of the tin oxide nanoparticles is usually carried out using the composition for forming an undercoat layer according to the present invention (namely, in a state where the tin oxide microparticles and the tin oxide nanoparticles are mixed).

The median diameter D₅₀ of the tin oxide microparticles is preferably 1 µm or more, more preferably 1.5 µm or more, and still more preferably 1.8 µm or more, from the viewpoint of improving the gas flowability in the undercoat layer. From the viewpoint of more effectively preventing the peeling of the undercoat layer from the substrate, on the other hand, the median diameter D₅₀ thereof is preferably 100 µm or less, more preferably 60 µm or less, and still more preferably 40 µm or less (for example, 30 µm or less, 25 µm or less, 20 µm or less, 15 µm or less, 10 µm or less or 5 µm or less).

The median diameter D₅₀ of the tin oxide nanoparticles is preferably 1 nm or more, more preferably 2 nm or more, and still more preferably 3 nm or more, from the viewpoint of improving the gas flowability in the undercoat layer. From the viewpoint of more effectively preventing the peeling of the undercoat layer from the substrate, on the other hand, the median diameter D₅₀ thereof is preferably 20 nm or less, more preferably 15 nm or less, and still more preferably 10 nm or less.

The ratio of the median diameter D₅₀ of the tin oxide microparticles to the median diameter D₅₀ of the tin oxide nanoparticles is preferably 50 or more, more preferably 100 or more, still more preferably 200 or more, from the viewpoints of improving the sinterability of the tin oxide nanoparticles and more effectively preventing the peeling of the undercoat layer from the substrate. From the viewpoint of improving the gas flowability in the undercoat layer, on the other hand, the above-described ratio is preferably 100,000 or less, more preferably 30,000 or less, and still more preferably 10,000 or less.

The particles constituting the tin oxide microparticles may be primary particles or secondary particles. The tin oxide microparticles are usually composed of a mixture of primary particles and secondary particles, mainly containing secondary particles.

The particles constituting the tin oxide nanoparticles may be primary particles or secondary particles. The tin oxide nanoparticles before being mixed with the tin oxide microparticles are usually composed of primary particles, or composed of a mixture of primary particles and secondary particles, mainly containing primary particles. However, the tin oxide nanoparticles after being mixed with the tin oxide microparticles may be adsorbed on the tin oxide microparticles to cause aggregation.

The median diameter D₅₀ of the primary particles (average primary particle size) constituting the tin oxide microparticles is preferably 15 nm or more and 100 nm or less, and more preferably 16 nm or more and 40 nm or less (for example, 16 nm or more and 35 nm or less, 16 nm or more and 30 nm or less, or 16 nm or more and 25 nm or less), from the viewpoint of obtaining a specific surface area appropriate as a catalyst carrier.

The median diameter D₅₀ of the primary particles constituting the tin oxide microparticles refers to the particle size at which the cumulative volume is 50% in the particle size distribution based on volume of the primary particles constituting the tin oxide microparticles.

The particle size distribution based on volume of the primary particles constituting the tin oxide microparticles is measured by the small angle X-ray scattering method. A preferred embodiment of the small angle X-ray scattering method is as described above.

It is preferred that the particle size distribution based on volume of the primary particles constituting the tin oxide microparticles do not overlap with the particle size distribution based on volume of the tin oxide nanoparticles (namely, that the minimum particle size in the particle size distribution based on volume of the primary particles constituting the tin oxide microparticles is larger than the maximum particle size in the particle size distribution based on volume of the tin oxide nanoparticles). By this arrangement, the measurement of the particle size distribution based on volume of the primary particles constituting the tin oxide microparticles can be carried out not only before mixing the tin oxide microparticles and the tin oxide nanoparticles, but also after mixing the tin oxide microparticles and the tin oxide nanoparticles.

The specific surface area of the tin oxide microparticles is preferably 1 m²/g or more, more preferably 10 m²/g or more, and still more preferably 30 m²/g or more, from the viewpoint of supporting a noble metal at a minute particle size to improve purification performance. From the viewpoint of improving the gas flowability in the undercoat layer to improve exhaust gas purification performance, on the other hand, the specific surface area thereof is preferably 120 m²/g or less, more preferably 90 m²/g or less, and still more preferably 70 m²/g or less.

The specific surface area of the tin oxide microparticles is measured according to JIS R1626, “Measuring methods for the specific surface area of fine ceramic powders by gas adsorption using the BET method,” “6.2 Flow method,” “(3.5) Single-point method.” In this method, a nitrogen-helium gas mixture containing 30% by volume of nitrogen as an adsorption gas and 70% by volume of helium as a carrier gas is used as a gas. “BELSORP-MR6” manufactured by MicrotracBEL Corp. is used as a measurement device.

In the composition for forming an undercoat layer according to the present invention, the content of the tin oxide nanoparticles is preferably 8% by mass or more and 30% by mass or less with respect to the total content of the tin oxide microparticles and the tin oxide nanoparticles.

An insufficient amount of the tin oxide nanoparticles as a binder component makes the tin oxide microparticles more susceptible to peeling off from the substrate. An excessive amount of the tin oxide nanoparticles as a binder component causes a decrease in the binder performance of the tin oxide nanoparticles due to aggregation of the tin oxide nanoparticles (such as aggregation due to sintering), making the tin oxide microparticles more susceptible to peeling off from the substrate. When the tin oxide microparticles peel off from the substrate, and a catalyst layer is formed on the substrate, not on the undercoat layer, there is a risk that the catalyst layer may fail to exhibit a sufficient catalytic performance. In cases where the substrate has a honeycomb structure, in particular, the portions of the catalyst layer formed at the corners of the cells of the substrate (corners of the cells when the substrate is seen in a plan view from the axial direction (exhaust gas flow direction) of the substrate) have a low contact efficiency with an exhaust gas, possibly failing to exhibit a sufficient catalytic performance. Further, when the tin oxide microparticles are susceptible to peeling off from the substrate, the catalyst layer is more likely to peel off from the substrate along with the undercoat layer even if the catalyst layer is formed on the undercoat layer, possibly failing to exhibit a sufficient catalytic performance.

In contrast, when the content of the tin oxide nanoparticles is 8% by mass or more and 30% by mass or less with respect to the total content of the tin oxide microparticles and the tin oxide nanoparticles, it is possible to prevent the tin oxide microparticles from peeling off from the substrate. Therefore, it is possible to prevent the catalyst layer from being formed on the substrate, not on the undercoat layer (to prevent, particularly at the corners of the cells of the substrate, the catalyst layer from being formed on the substrate, not on the undercoat layer), and to prevent the catalyst layer from peeling off from the substrate along with the undercoat layer, allowing the catalyst layer to effectively exhibit the catalytic performance.

The content of the tin oxide nanoparticles is more preferably 9% by mass or more and 25% by mass or less, and still more preferably 10% by mass or more and 20% by mass or less, with respect to the total content of the tin oxide microparticles and the tin oxide nanoparticles, from the viewpoint of more effectively preventing the peeling of the undercoat layer from the substrate.

Examples of the form of the composition for forming an undercoat layer include a powder, a dispersion liquid and the like. The dispersion liquid contains the tin oxide microparticles, the tin oxide nanoparticles and a dispersion medium. The dispersion liquid has any of various viscosities depending on a content of a solid component, and may take any of various forms, such as an ink, a slurry or a paste, depending on the viscosity. The dispersion liquid is preferably in the form of a slurry. Examples of the dispersion medium contained in the dispersion liquid include water, organic solvents and the like. The dispersion medium may be a single solvent, or may be a mixture of two or more solvents. The mixture of two or more solvents may be, for example, a mixture of water and one or two or more organic solvents, a mixture of two or more organic solvents, or the like.

The composition for forming an undercoat layer according to the present invention can be prepared, for example, by mixing a tin oxide powder composed of the tin oxide microparticles and a tin oxide sol containing the tin oxide nanoparticles. The thus prepared composition for forming an undercoat layer is in the form of a dispersion liquid, preferably a slurry.

Each of the tin oxide powder composed of the tin oxide microparticles and the tin oxide sol containing the tin oxide nanoparticles can be produced in accordance with a conventional method.

The tin oxide powder composed of the tin oxide microparticles can be produced, for example, by grinding a calcined product obtained by subjecting tin oxide to a heat treatment. The grinding of the calcined product can be carried out by a dry process or a wet process, for example, using a jet mill, a ball mill, a bead mill or the like. In the case of carrying out the grinding by a wet process, it is possible to use, for example, an organic solvent such as a hydrocarbon solvent as a solvent. After the grinding, a sieve with a predetermined aperture may be used to perform classification. Grinding conditions, the aperture of the sieve to be used for the classification, and the like can be adjusted as appropriate depending on the median diameter D₅₀, D₉₀ and D₁₀ that should be achieved.

The tin oxide sol containing the tin oxide nanoparticles can be produced, for example, by a method in which a tin oxide powder is used to obtain a tin oxide sol, a method in which tin oxide is formed in a solvent to obtain a tin oxide sol, or the like. Examples of the latter method include methods described in JP 2011-26172 A and JP 2012-148928 A. The tin oxide sol containing the tin oxide nanoparticles is preferably a monodispersed sol.

The composition for forming an undercoat layer according to the present invention may contain a solid component other than the tin oxide microparticles and the tin oxide nanoparticles. The solid component other than the tin oxide microparticles and the tin oxide nanoparticles may be, for example, metal oxide particles other than the tin oxide particles, or the like. The metal oxide particles will be described later.

In cases where the composition for forming an undercoat layer according to the present invention contains a solid component other than the tin oxide microparticles and the tin oxide nanoparticles, the content thereof is preferably 2% by mass or less with respect to the mass of the composition for a forming an undercoat layer.

### Undercoat Layer

The undercoat layer according to the present invention is formed by the composition for forming an undercoat layer according to the present invention. The undercoat layer according to the present invention is, for example, a dried product or a calcined product of the composition for forming an undercoat layer according to the present invention.

The most frequent pore size of the undercoat layer according to the present invention is preferably 200 nm or more and 1,000 nm or less, more preferably 300 nm or more and 800 nm or less, and still more preferably 350 nm or more and 600 nm or less, from the viewpoint of the balance between the gas flowability in the undercoat layer and the effect of preventing the peeling of the undercoat layer.

The expression “the most frequent pore size of the undercoat layer is 200 nm or more and 1,000 nm or less” means that the highest peak is present within the range of the pore volume size of from 200 nm to 1,000 nm, in the logarithmic differential pore volume distribution (measurement range of the pore volume size: from 3 nm to 100 µm) of the undercoat layer as measured by a mercury intrusion porosimeter. It is noted here that a peak with a vertical height of less than 0.002 mL/g from the line based on the assumption that no peak is present, namely the background, is considered as noise, and thus does not correspond to the “peak”.

The most frequent pore size of the undercoat layer can be determined by measuring the pore distribution with a mercury intrusion porosimeter, using the undercoat layer when the undercoat layer is present singly, using the undercoat layer after being peeled off from the substrate when the undercoat layer has been formed on the substrate, and using the undercoat layer after removing the catalyst layer when the catalyst layer has been formed on the undercoat layer. The measurement of the most frequent pore size of the undercoat layer may be carried out using a fragment of the undercoat layer (for example, a fragment of the undercoat layer peeled off from the substrate).

The mercury intrusion porosimeter is an apparatus that allows mercury to intrude into the object to be measured by applying a pressure thereto, utilizing the fact that mercury has a large surface tension, and measures the pore volume size and the logarithmic differential pore volume distribution from the pressure and the amount of mercury intruded into the object by the pressure at this time. Therefore, the target pores are only open pores (pores communicating with the outside), and closed pores (independent pores) are not included in the target pores.

The term “pore volume size” refers to the diameter of the bottom face of a column when the pores are approximated to the column, and is calculated by the following equation.

dr = -4 σcosθ/p (σ: surface tension, θ: contact angle, p: pressure)

In this equation, the surface tension of mercury is known and mercury shows a unique contact angle value depending on the apparatus used, and therefore, it is possible to calculate the pore volume size from the pressure of the pressure-intruded mercury.

The most frequent pore size of the undercoat layer according to the present invention can be adjusted by controlling the content, the specific surface area, the calcination conditions and the like of the tin oxide microparticles.

The undercoat layer according to the present invention can be formed by coating the composition for forming an undercoat layer according to the present invention on a substrate, and drying the composition (in this case, the undercoat layer according to the present invention is a dried product of the composition for forming an undercoat layer according to the present invention), or by calcining the dried product after drying (in this case, the undercoat layer according to the present invention is a calcined product of the composition for forming an undercoat layer according to the present invention).

The drying temperature is usually 80° C. or higher and 400° C. or lower, and preferably 100° C. or higher and 300° C. or lower; and the drying time is usually 1 hour or more and 15 hours or less, and preferably 3 hours or more and 12 hours or less. The calcination temperature is usually 400° C. or higher and 1000° C. or lower, and preferably 500° C. or higher and 800° C. or lower; and the calcination time is usually 1 hour or more and 10 hours or less, and preferably 2 hours or more and 5 hours or less. The calcination can be carried out, for example, in an air atmosphere.

The fact that the undercoat layer according to the present invention is formed by the composition for forming an undercoat layer according to the present invention, can be confirmed by: observing three points arbitrarily selected from a cross section of the undercoat layer; calculating the percentage S (%) of the area N of the portion formed by the tin oxide nanoparticles to the total area T of the portions formed by the tin oxide microparticles and the tin oxide nanoparticles, for each of the three points, by the equation S = 100 × N/T; and confirming the above-described fact based on the mean value of the thus obtained percentages. The cross-sectional observation of the undercoat layer can be carried out by: cutting the undercoat layer formed on the substrate in a plane perpendicular to the axial direction (exhaust gas flow direction) of the substrate; processing the cross section with a cooling cross section polisher; and then observing the cross section by SEM at a magnification of 2,000 times. When the undercoat layer according to the present invention is formed by the composition for forming an undercoat layer according to the present invention, the mean value of the above-described percentages is preferably 1.7% or more and 44% or less, more preferably 2% or more and 40% or less, still more preferably 2.5% or more and 35% or less, and yet still more preferably 5.0% or more and 10% or less.

### Exhaust Gas Purification Catalyst

The exhaust gas purification catalyst according to the present invention includes: a substrate; the undercoat layer according to the present invention formed on the substrate; and a catalyst layer formed on the undercoat layer.

The substrate can be selected as appropriate from substrates generally used as substrates for exhaust gas purification catalysts. The substrate may be, for example, a wall-flow substrate, a flow-through substrate, or the like.

The material forming the substrate can be selected as appropriate from materials generally used as the materials of substrates for exhaust gas purification catalysts. The material forming the substrate is preferably a material capable of stably maintaining the shape of the substrate, even in cases where the substrate is exposed to a high-temperature (for example, 400° C. or higher) exhaust gas.

The material of the substrate may be, for example, a ceramic material, a metallic material or the like. Examples of the ceramic material include fire-resistant ceramic materials, such as cordierite, cordierite-alpha alumina, silicon nitride, zircon-mullite, spodumene, alumina-silica magnesia, zirconium silicate, sillimanite, magnesium silicate, zircon, petalite, alpha alumina and aluminosilicate. Examples of the metallic material include fire-resistant metallic materials, such as stainless steels and iron-based alloys.

The substrate preferably has a honeycomb structure. It is possible to use, for example, a honeycomb structure made of a ceramic material such as cordierite, a honeycomb structure (metal honeycomb) made of a metallic material such as stainless steel, or the like, as the substrate having a honeycomb structure. Further, it is possible to use, for example, a monolithic substrate that includes a number of minute gas flow passages (channels) extending in parallel with each other in the interior of the substrate so as to allow a fluid to pass through the interior of the substrate, as the substrate having a honeycomb structure.

The form of the substrate is not particularly limited, and the substrate may be in the form of, for example, a tube, pellets, spheres or the like. The form of the tube may be, for example, that of a cylinder, an elliptic cylinder, a polygonal cylinder or the like.

The ratio (WC2/WC1) of the mass of the catalyst layer per unit volume of the substrate (hereinafter, also referred to as the “coating amount (WC2) of the catalyst layer”) to the mass of the undercoat layer per unit volume of the substrate (hereinafter, also referred to as the “coating amount (WC1) of the undercoat layer”) is preferably 0.1 or more and 10 or less, more preferably 0.5 or more and 5 or less, and still more preferably 1 or more and 3 or less. When the ratio WC2/WC1 is within the range described above, the probability of contact between a component (such as methane) in an exhaust gas and a noble metal in the catalyst is increased, and the catalytic performance (such as methane purification performance) of the catalyst layer can be effectively exhibited.

The catalyst layer contains one or more catalytically active components. The catalytically active component contains, for example, one or more noble metal elements selected from platinum (Pt) element, palladium (Pd) element, rhodium (Rh) element, ruthenium (Ru) element, iridium (Ir) element, osmium (Os) element and the like. The catalytically active component containing a noble metal element is, for example, a noble metal, an oxide of a noble metal, an alloy containing a noble metal element, or the like.

The mass of the catalytically active component per unit volume of the substrate (in cases where the catalyst layer contains two or more kinds of catalytically active components, the total mass of the two or more kinds of catalytically active components) can be adjusted as appropriate considering the balance between the exhaust gas purification performance and the cost, and the like. The mass of the catalytically active component per unit volume of the substrate is usually 1 g/L or more and 30 g/L or less, and preferably 3 g/L or more and 20 g/L or less.

The method of measuring the mass of the catalytically active component per unit volume of the substrate is as follows.

The exhaust gas purification catalyst is cut by a plane perpendicular to the axis direction of the substrate (the exhaust gas flow direction) to prepare a cut piece C1 that contains a part of the catalyst layer. The cut piece C1 has a determined size. The diameter and length of the cut piece C1 can be adjusted as appropriate. The length of the catalyst layer contained in the cut piece C1 is equal to the length of the cut piece C1. That is, the catalyst layer extends from one end of the cut piece C1 to the other end of the cut piece C1.

Using a conventional method such as inductively coupled plasma atomic emission spectroscopy (ICP-AES), the mass of the catalytically active component contained in the cut piece C1 is measured, from which the mass of the catalytically active component per unit volume of the cut piece C1 is calculated according to the following equation.

the mass of the catalytically active component per unit volume of the cut piece C1 = the mass of the catalytically active component contained in the cut piece C1 / the volume of the cut piece C1

The mass of the catalytically active component per unit volume of the cut piece C1 is calculated for each of five cut pieces C1, and the mean value of the calculated values is defined as the mass of the catalytically active component per unit volume of the substrate.

The catalyst layer contains one or more carriers, and the catalytically active component is preferably supported on the carrier(s).

The phrase “the catalytically active component is supported on the carrier” means that the catalytically active component is physically or chemically adsorbed or retained on the outer surfaces, or on the inner surfaces of pores, of the carrier. For example, the catalytically active component can be determined to be supported on the carrier, when the catalytically active component and the carrier exist in the same region in an element mapping obtained by analyzing a cross section of the catalyst layer by energy dispersive spectroscopy (EDS). In addition, measuring the particle size using a scanning electron microscope (SEM) makes it possible to verify that the catalytic active component is supported on the carrier.

The average particle size of the catalytically active component existing in the surface of the carrier is preferably 10% or less, more preferably 3% or less, and still more preferably 1% or less, relative to the average particle size of the carrier. Here, the average particle size refers to the average value of the Feret diameters of 30 or more particles as observed by SEM.

The mass of the carrier per unit volume of the substrate (in cases where the catalyst layer contains two or more kinds of carriers, the total mass of the two or more kinds of carriers) can be adjusted as appropriate considering the balance between the exhaust gas purification performance and the cost, and the like. The mass of the carrier per unit volume of the substrate is usually 30 g/L or more and 300 g/L or less, and preferably 50 g/L or more and 200 g/L or less. The method of measuring the mass of the carrier per unit volume of the substrate is the same as the method of measuring the mass of the catalytically active component per unit volume of the substrate.

The carrier may be, for example, metal oxide particles. The metal oxide forming the metal oxide particles may be a metal oxide having an oxygen storage capacity (OSC) (hereinafter, also referred to as “oxygen storage component”), or may be an inorganic oxide other than the oxygen storage component.

The median diameter D₅₀ of the metal oxide particles is usually 1 µm or more and 100 µm or less, and preferably 1.5 µm or more and 50 µm or less. The median diameter D₅₀ of the metal oxide particles refers to the particle size at which the cumulative volume is 50% in the particle size distribution based on volume of the metal oxide particles. The method of measuring the particle size distribution based on volume of the metal oxide particles is the same as the method of measuring the particle size distribution based on volume of the tin oxide microparticles.

The metal oxide particles are preferably porous bodies, because the catalytically active component can be more easily supported thereon. The specific surface area of the metal oxide particles is usually 10 m²/g or more and 120 m²/g or less, and preferably 20 m²/g or more and 90 m²/g or less. The method of measuring the specific surface area of the metal oxide particles is the same as the method of measuring the specific surface area of the tin oxide microparticles.

The oxygen storage component may be, for example, a metal oxide containing cerium (Ce) element, or the like. The metal oxide containing cerium element may be, for example, cerium oxide (CeO₂), a composite oxide containing cerium (Ce) element and zirconium (Zr) element (hereinafter, also referred to as “CeO₂—ZrO₂—based composite oxide”), or the like.

Examples of the inorganic oxide other than the oxygen storage component include tin oxide, alumina, silica, silica-alumina, aluminosilicate, alumina-zirconia, alumina-chromia, alumina-ceria, alumina-lanthana, titania and the like. The description of the tin oxide is the same as that described above.

In one embodiment, the carrier contains tin oxide, and the catalytically active component contains platinum element. The exhaust gas purification catalyst according to this embodiment is useful as a methane oxidation catalyst that oxidizes methane in an exhaust gas. The methane oxidation catalyst is used, for example, at a temperature of 250° C. or higher and 500° C. or lower, and preferably 300° C. or higher and 450° C. or lower.

The carrier containing tin oxide is, for example, tin oxide particles. The catalytically active component containing platinum element is, for example, platinum metal, an alloy containing platinum element, or the like. The catalytically active component may contain one or more noble metal elements (for example, iridium element) other than platinum element. The catalytically active component containing iridium element is, for example, iridium metal, an alloy containing iridium element, or the like.

The exhaust gas purification catalyst according to the present invention may further include a third layer provided on the catalyst layer. Providing the third layer on the catalyst layer enables to prevent poisoning of the catalytically active component that occurs as a result of the adhesion of the components in an exhaust gas to the catalyst layer, making it possible for the catalyst layer to effectively exhibit the catalytic performance.

The composition of the third layer can be adjusted as appropriate depending on the functions and the like required for the third layer.

The third layer contains, for example, one or more kinds of metal oxide particles. The description of the metal oxide particles is the same as that described above. The third layer may contain one or more components other than the metal oxide particles.

In one embodiment, the third layer contains tin oxide particles. The description of the tin oxide particles is the same as that described above. This embodiment is preferably combined with the above-described embodiment in which the carrier contains tin oxide, and the catalytically active component contains platinum element. The exhaust gas purification catalyst according to the combined embodiment is useful as a methane oxidation catalyst that oxidizes methane in an exhaust gas.

In one embodiment, the third layer is a dried product or a calcined product of the composition for forming an undercoat layer according to the present invention. This enables to prevent the third layer from peeling off from the catalyst layer, making it possible for the catalyst layer to effectively exhibit the catalytic performance.

The exhaust gas purification catalyst according to the present invention can be formed by coating a composition for use in an exhaust gas purification catalyst on the undercoat layer, followed by drying and calcining, after forming the undercoat layer according to the present invention on the substrate.

The drying temperature is usually 80° C. or higher and 400° C. or lower, and preferably 100° C. or higher and 300° C. or lower; and the drying time is usually 1 hour or more and 15 hours or less, and preferably 3 hours or more and 12 hours or less. The calcination temperature is usually 400° C. or higher and 800° C. or lower, and preferably 500° C. or higher and 600° C. or lower; and the calcination time is usually 1 hour or more and 10 hours or less, and preferably 2 hours or more and 5 hours or less. The calcination can be carried out, for example, in an air atmosphere.

Examples of the form of the composition for use in an exhaust gas purification catalyst include a dispersion liquid, preferably a slurry. Examples of the dispersion medium contained in the dispersion liquid include water, organic solvents and the like. The dispersion medium may be a single solvent, or may be a mixture of two or more solvents. The mixture of two or more solvents may be, for example, a mixture of water and one or two or more organic solvents, a mixture of two or more organic solvents, or the like.

The composition of the composition for use in an exhaust gas purification catalyst can be adjusted as appropriate depending on the composition of the exhaust gas purification catalyst. The composition for use in an exhaust gas purification catalyst contains, for example, a supply source of the catalytically active component, a carrier and the like.

The supply source of the catalytically active component is, for example, a noble metal salt. The noble metal salt (including noble metal ions generated by the electrolytic dissociation of the noble metal salt) is preferably impregnated into the carrier. The noble metal salt (including noble metal ions generated by the electrolytic dissociation of the noble metal salt) can be impregnated into the carrier, by mixing a solution containing the noble metal salt and the carrier. The noble metal salt may be, for example, a nitrate salt, an ammine complex salt, a chloride salt or the like.

The content of the supply source of the catalytically active component in the composition for use in an exhaust gas purification catalyst is usually 0.5% by mass or more and 20% by mass or less, preferably 1% by mass or more and 15% by mass or less, with respect to the mass of the composition for use in an exhaust gas purification catalyst.

The content of the carrier in the composition for use in an exhaust gas purification catalyst is usually 5% by mass or more and 40% by mass or less, preferably 10% by mass or more and 30% by mass or less, with respect to the mass of the composition for use in an exhaust gas purification catalyst.

The composition for use in an exhaust gas purification catalyst may contain a binder component. Examples of the binder component include metal oxide sols such as colloidal silica, colloidal alumina, titanium oxide sols, cerium oxide sols and tin oxide sols.

The content of the binder component in the composition for use in an exhaust gas purification catalyst is usually 8% by mass or more and 30% by mass or less, preferably 10% by mass or more and 20% by mass or less, with respect to the mass of the composition for use in an exhaust gas purification catalyst.

### Exhaust Gas Purification Apparatus

The exhaust gas purification apparatus according to the present invention includes the exhaust gas purification catalyst according to the present invention.

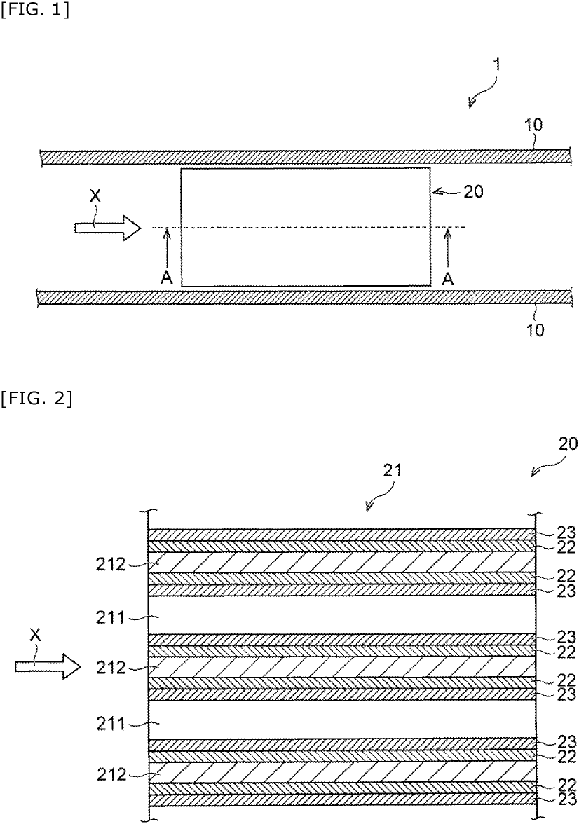

Embodiments of the exhaust gas purification apparatus according to the present invention will be described below with reference to FIG. 1 and FIG. 2. FIG. 1 is a partial cross-sectional view of an exhaust gas purification apparatus 1 according to one embodiment of the present invention, and FIG. 2 is a cross-sectional view of the apparatus shown in FIG. 1 taken along the line A-A.

The exhaust gas purification apparatus 1 is provided, for example, in an exhaust path of a gasoline engine (such as a GDI engine), a boiler, a heating furnace, a gas engine, a gas turbine or the like.

As shown in FIG. 1, the exhaust gas purification apparatus 1 includes an exhaust pipe 10, and an exhaust gas purification catalyst 20 provided in the exhaust pipe 10. Exhaust gas flows through an exhaust gas path in the exhaust pipe 10 from the one end of the exhaust pipe 10 toward the other end, and is purified by the exhaust gas purification catalyst 20 provided in the exhaust pipe 10. In FIG. 1, the exhaust gas flow direction is denoted by the reference sign X. In the present description, the upstream position in the exhaust gas flow direction X is referred to as the “exhaust gas inflow side”, and the downstream position in the exhaust gas flow direction X is referred to as the “exhaust gas outflow side”, in some cases.

As shown in FIG. 2, the exhaust gas purification catalyst 20 includes a substrate 21, an undercoat layer 22 formed on the substrate 21, and a catalyst layer 23 formed on the undercoat layer 22. The exhaust gas purification catalyst 20 corresponds to the exhaust gas purification catalyst according to the present invention, and the undercoat layer 22 corresponds to the undercoat layer according to the present invention.

The substrate 21 is, for example, a flow-through type substrate 31 having a honeycomb structure.

As shown in FIG. 2, the substrate 21 includes cells 211 and a partition wall 212 separating the cells 211 from one another. In the substrate 21, the partition wall 212 is present between two adjacent cells 211, whereby the two adjacent cells 211 are separated from each other by the partition wall 212. The substrate 21 includes a tubular member (not shown) that defines the external shape of the substrate 21. The partition wall 212 is formed in the tubular member. The tubular member has, for example, a hollow cylindrical shape, but may have another shape. Examples of the other shape include a hollow elliptic cylindrical shape, a polygonal tubular shape and the like. The axial direction of the tubular member is coincident with the axial direction of the substrate 21.

As shown in FIG. 2, holes each having an open end on the exhaust gas inflow side and an open end on the exhaust gas outflow side are formed in the substrate 21. The spaces in these holes form the cells 211.

As shown in FIG. 2, the cells 211 each extend in the exhaust gas flow direction X, and each have an end on the exhaust gas inflow side in the exhaust gas flow direction X and an end on the exhaust gas outflow side in the exhaust gas flow direction X. As shown in FIG. 2, the end on the exhaust gas inflow side in the exhaust gas flow direction X and the end on the exhaust gas outflow side in the exhaust gas flow direction X are both open. Hereinafter, the end on the exhaust gas inflow side of each cell 211 may be referred to as “the opening on the exhaust gas inflow side”, and the end on the exhaust gas outflow side of each cell 211 may be referred to as “the opening on the exhaust gas outflow side”.

Examples of the shape in a plan view of the opening on the exhaust gas inflow or outflow side of each cell 211 (the shape when the substrate 21 is viewed in a plan view from the exhaust gas flow direction X) include various geometric shapes, including: rectangles such as square, parallelograms, rectangles and trapezoids; polygons such as triangles, hexagons and octagons; and circles and ovals.

The area of the shape in a plan view of the opening on the exhaust gas inflow side of each cell 211 may be the same as or different from the area of the shape in a plan view of the opening on the exhaust gas outflow side of each cell 211.

The cell density per square inch of the substrate 21 is, for example, 100 cells or more and 1200 cells or less. The cell density per square inch of the substrate 21 means the total number of cells 211 per square inch of a cross-section obtained by cutting the substrate 21 by a plane perpendicular to the exhaust gas flow direction X.

The thickness of the partition wall 212 is, for example, from 10 µm to 80 µm. If the thickness of the partition wall 212 is not constant, the average value of the thicknesses obtained from a plurality of measurement points will be considered as the thickness of the partition wall 212.

As shown in FIG. 2, the undercoat layer 22 is formed on each side of the partition wall 212 from the end on the exhaust gas inflow side of the partition wall 212 to the end on the exhaust gas outflow side of the partition wall 212 along the exhaust gas flow direction X.

The undercoat layer 22 may be formed on a part of the partition wall 212 from the end on the exhaust gas inflow side of the partition wall 212 along the exhaust gas flow direction X. Alternatively, the undercoat layer 22 may be formed on a part of the partition wall 212 from the end on the exhaust gas outflow side of the partition wall 212 along a direction opposite to the exhaust gas flow direction X.

As shown in FIG. 2, the catalyst layer 23 is formed on the undercoat layer 22 from the end on the exhaust gas inflow side of the partition wall 212 to the end on the exhaust gas outflow side of the partition wall 212 along the exhaust gas flow direction X. The catalyst layer 23 may be formed on the whole part of the undercoat layer 22, or a part of the undercoat layer 22.

### EXAMPLES

### Example 1

Tin oxide (Pastran 6010, manufactured by Mitsui Mining & Smelting Co., Ltd.) was calcined at 900° C. for 3 hours in an air atmosphere, to prepare tin oxide microparticles. The median diameter D₅₀, the pore size and the BET specific surface area of the tin oxide microparticles were 2.0 µm, 30 nm and 30 m²/g, respectively.

A tin oxide sol (Tin oxide sol S-8, manufactured by Taki Chemical Co., Ltd.) which is an inorganic binder was prepared. The median diameter D₅₀ of tin oxide nanoparticles contained in the tin oxide sol was 6 nm.

A metal honeycomb made of stainless steel was prepared as a substrate. The substrate was cut in a plane perpendicular to the axial direction of the substrate, to prepare a cut piece (the number of cells: 400 cells, diameter: 20 mm, length: 12.5 mm, volume: 3.9 mL) of the substrate. The cut piece of the substrate was calcined at 700° C. for one hour, to remove oil and dust adhered to the substrate.

The tin oxide microparticles and the tin oxide sol were mixed such that the content of the tin oxide nanoparticles was 8% by mass with respect to the total content of the tin oxide microparticles and the tin oxide nanoparticles, and the resulting mixture was stirred for 2 hours to prepare a slurry for forming an undercoat layer.

Thereafter, the median diameter D₅₀ of the tin oxide microparticles present in the slurry for forming an undercoat layer was measured in accordance with the dynamic light scattering method described above, and the median diameter D₅₀ of the tin oxide nanoparticles present in the slurry for forming an undercoat layer was measured in accordance with the small angle X-ray scattering method described above, to confirm that the median diameters D₅₀ of these particles were 2.0 µm and 6 nm, respectively.

Further, the median diameter D₅₀ of the primary particles (average primary particle size) constituting the tin oxide microparticles, which are present in the slurry for forming an undercoat layer, was measured in accordance with the small angle X-ray scattering method described above, to confirm that the median diameter D₅₀ thereof was 19 nm.

Subsequently, tin oxide (Pastran 6010, manufactured by Mitsui Mining & Smelting Co., Ltd.) was calcined at 600° C. for 3 hours in an air atmosphere, to prepare tin oxide particles for use as a carrier. The median diameter D₅₀, the pore size and the BET specific surface area of the tin oxide particles for use as a carrier were 2.0 µm, 20 nm and 40 m²/g, respectively.

A platinum nitrate solution, an iridium nitrate solution and pure water were mixed, and then the tin oxide particles for use as a carrier and the tin oxide sol were added thereto. The resulting mixture was stirred for 2 hours, to prepare a slurry for forming a catalyst layer in which the contents of platinum (Pt) element, iridium (Ir) element, the tin oxide particles for use as a carrier and the tin oxide sol were 12 parts by mass, 1.2 parts by mass, 76.8 parts by mass and 10 parts by mass, respectively.

The cut piece of the substrate was immersed in the slurry for forming an undercoat layer, and air blowing was carried out to remove an excessive amount of slurry in the cells and to dry the slurry. Thereafter, the dried cut piece was calcined at 500° C. for 3 hours in an air atmosphere, to form an undercoat layer whose mass per unit volume of the cut piece of the substrate was 60 g/L.

A fragment of the undercoat layer was collected from the substrate on which the undercoat layer had been formed, and the pore size evaluation of the collected fragment of the undercoat layer was carried out by mercury porosimetry. As a result, the most frequent pore size was 380 nm.

After forming the undercoat layer, the cut piece of the substrate was immersed in the slurry for forming a catalyst layer, and air blowing was carried out to remove an excessive amount of slurry in the cells and to dry the slurry. Thereafter, the dried cut piece was calcined at 500° C. for 3 hours in an air atmosphere, to form a catalyst layer whose mass per unit volume of the cut piece of the substrate was 125 g/L. A catalyst sample was prepared in this manner.

In the thus prepared catalyst sample, the amounts of platinum element and iridium element supported per unit volume of the cut piece of the substrate, in terms of metal, were 15 g/L and 1.5 g/L, respectively.

### Evaluations

The methane purification efficiency (%) at 340° C. of the catalyst sample was measured. The measured result is shown in Table 1. The measurement method is as follows.

The catalyst sample was set in a quartz tube with a diameter of about 21 mm. A gas mixture composed of 2,000 ppm of methane, 10 vol% of oxygen, 5 vol% of carbon dioxide, 10 vol% of water vapor, and nitrogen as the balance, was used as a simulated exhaust gas, and the gas flow rate was set to a space velocity of 40,000 h⁻¹. The “space velocity” as used herein refers to the flow rate of a gas flowing per hour per volume of a honeycomb catalyst sample. The catalyst sample was heated to 340° C. in a tube furnace disposed around the quartz tube, and then the concentration of methane was measured.

The peeling rate (%) of the undercoat layer and the catalyst layer of the catalyst sample was measured. The measured result is shown in Table 1. The measurement method is as follows.

The catalyst sample was dried at 150° C. for one hour. After drying, the mass W1 of the catalyst sample was measured. After measuring the mass W1, air blowing was carried out 3 times, using an air gun. The air blowing was carried out under the conditions of an air pressure of 0.4 Mpa, a distance between the air gun and the catalyst sample of 5 cm, and a duration of 10 seconds. After the completion of the third air blowing, the mass W2 of the catalyst sample was measured.

The peeling rate (%) of the undercoat layer and the catalyst layer was calculated based on the following equation.

Peeling rate of undercoat layer and catalyst layer (%) = (mass W1 - mass W2)/mass W1 × 100

The measured results of the methane purification efficiency and the peeling rate are shown in Table 1.

### Examples 2 to 4 and Comparative Examples 1 to 3

Catalyst samples were prepared in the same manner as in Example 1, except that, in each of the Examples and Comparative Examples, the tin oxide microparticles and the tin oxide sol were mixed such that the content of the tin oxide nanoparticles with respect to the total content of the tin oxide microparticles and the tin oxide nanoparticles achieved the proportion shown in Table 1, to form a slurry for forming an undercoat layer. In addition, the methane purification efficiency and the peeling rate were measured. The measured results are shown in Table 1. [Table 1]

TABLE 1

| | Content of tin oxide nanoparticles | Peeling rate of Undercoat layer and catalyst layer | Methane purification efficiency at 340° C. |
|---|---|---|---|
| Example 1 | 8% by mass | 1.7% | 44% |
| Example 2 | 10% by mass | 1.7% | 45% |
| Example 3 | 15% by mass | 1.6% | 45% |
| Example 4 | 20% by mass | 0.1% | 35% |
| Comparative Example 1 | 5% by mass | 6.2% | 33% |
| Comparative Example 2 | 50% by mass | 1.1% | 16% |
| Comparative Example 3 | (without undercoat layer) | 1.6%* | 33% |

*Peeling rate of catalyst layer alone

As shown in Table 1, when the content of the tin oxide nanoparticles in the slurry for forming an undercoat layer is 8% by mass or more and 30% by mass or less with respect to the total content of the tin oxide microparticles and the tin oxide nanoparticles in the slurry for forming an undercoat layer (Examples 1 to 4), it was possible to prevent the peeling of the undercoat layer and the catalyst layer from the substrate, making it possible for the catalyst layer effectively exhibit the catalytic performance (methane purification performance).

In Comparative Example 2, the occurrence of a partial peeling of the undercoat layer was observed although the peeling rate was 1.1%, which was a relatively low value, because of an excessive content of the tin oxide nanoparticles in the slurry for forming an undercoat layer, resulting in a poor methane purification efficiency.

### Cross-Sectional Observation

Three points (visual fields 1 to 3) arbitrarily selected from a cross section of the undercoat layer of Example 2 were observed, and the percentage (P) of the area (S2) of the portion formed by the tin oxide nanoparticles to the total area (S1) of the portions formed by the tin oxide microparticles and the tin oxide nanoparticles was calculated for each of the three points, and the mean value of the thus obtained percentages was calculated. The mean value of the above-described percentages was calculated in the same manner, for the undercoat layer of Comparative Example 1 and the undercoat layer of Comparative Example 2. The measured results are shown in Table 2. [Table 2]

TABLE 2

| | | Example 2 | Comparative Example 1 | Comparative Example 2 |
|---|---|---|---|---|
| Visual field 1 | S1 | 54.54 µm² | 50.62 µm² | 92.26 µm² |
| | S2 | 1.22 µm² | 0.07 µm² | 54.92 µm² |
| | P | 2.24% | 0.14% | 59.53% |
| Visual field 2 | S1 | 50.47 µm² | 48.91 µm² | 100.72 µm² |
| | S2 | 2.59 µm² | 0.32 µm² | 45.04 µm² |
| | P | 5.13% | 0.65% | 44.72% |
| Visual field 3 | S1 | 64.39 µm² | 42.19 µm² | 93.28 µm² |
| | S2 | 6.26 µm² | 0.70 µm² | 44.02 µm² |
| | P | 9.72% | 1.66% | 47.19% |
| Mean value of P | | 5.70% | 0.82% | 50.48% |

### Examples 5 to 8

Catalyst samples were prepared in the same manner as in Example 1, except that, in each of the Examples and Comparative Examples, the content of the tin oxide nanoparticles in the slurry for forming an undercoat layer was adjusted to 10% by mass with respect to the total content of the tin oxide microparticles and the tin oxide nanoparticles, and that the mass of the undercoat layer per unit volume of the cut piece of the substrate (hereinafter, also referred to as the “coating amount (WC1) of the undercoat layer”) and the mass of the catalyst layer per unit volume of the cut piece of the substrate (hereinafter, also referred to as the “coating amount (WC2) of the catalyst layer”) were adjusted to the proportions shown in Table 2. In addition, the methane purification efficiency and the peeling rate were measured. The measured results are shown in Table 3. In each of Examples 5 to 8, the amounts of platinum element and iridium element supported per unit volume of the cut piece of the substrate, in terms of metal, were fixed to 15 g/L and 1.5 g/L, respectively. [Table 3]

TABLE 3

| | Coating amount of undercoat layer (WC1) | Coating amount of catalyst layer (WC2) | Ratio of coating amount of catalyst layer to coating amount of undercoat layer (WC2/WC1) | Methane Purification Efficiency at 340° C. |
|---|---|---|---|---|
| Example 5 | 59.4 g/L | 65.5 g/L | 1.1 | 33% |
| Example 6 | 61.9 g/L | 83.3 g/L | 1.3 | 28% |
| Example 7 | 59.0 g/L | 119.7 g/L | 2.0 | 22% |
| Example 8 | 62.2 g/L | 188.0 g/L | 3.0 | 16% |

As shown in Table 3, the lower the coating amount of the catalyst layer, namely, the higher the concentration of the noble metals contained in the catalyst layer (Examples 5 to 8), the higher the probability of contact between methane in the exhaust gas and the noble metals in the catalyst, and thus it was possible for the catalyst layer to effectively exhibit the catalytic performance (methane purification performance).

1. A composition for forming an undercoat layer, the composition comprising tin oxide microparticles and tin oxide nanoparticles,
wherein a content of the tin oxide nanoparticles is 8% by mass or more and 30% by mass or less, with respect to a total content of the tin oxide microparticles and the tin oxide nanoparticles.

2. The composition for forming an undercoat layer according to claim 1, wherein a ratio of a median diameter D₅₀ of the tin oxide microparticles to a median diameter D₅₀ of the tin oxide nanoparticles is 50 or more and 100,000 or less.

3. The composition for forming an undercoat layer according to claim 1, wherein a median diameter D₅₀ of the tin oxide microparticles is 1 µm or more and 100 µm or less, and a median diameter D₅₀ of the tin oxide nanoparticles is 1 nm or more and 20 nm or less.

4. The composition for forming an undercoat layer according to claim 1, wherein the tin oxide microparticles have a specific surface area of 1 m²/g or more and 120 m²/g or less.

5. An undercoat layer formed by the composition for forming an undercoat layer according to claim 1.

6. The undercoat layer according to claim 5, wherein a most frequent pore size of the undercoat layer is 200 nm or more and 1,000 nm or less.

7. An exhaust gas purification catalyst comprising:
a substrate;
the undercoat layer according to claim 5 formed on the substrate; and
a catalyst layer formed on the undercoat layer.

8. The exhaust gas purification catalyst according to claim 7, wherein the substrate has a honeycomb structure.

9. The exhaust gas purification catalyst according to claim 7, wherein a ratio of a mass of the catalyst layer per unit volume of the substrate to a mass of the undercoat layer per unit volume of the substrate is 0.1 or more and 10 or less.

10. The exhaust gas purification catalyst according to claim 7, wherein the catalyst layer comprises a carrier, and a catalytically active component supported on the carrier.

11. The exhaust gas purification catalyst according to claim 10, wherein the carrier comprises tin oxide, and the catalytically active component comprises platinum element.

12. The exhaust gas purification catalyst according to claim 11, wherein the exhaust gas purification catalyst is a methane oxidation catalyst that oxidizes methane in an exhaust gas.

13. An exhaust gas purification apparatus comprising the exhaust gas purification catalyst according to claim 7.
